(19) United States
(12) Patent Application Publication
(10) Pub. No.: US 2010/0124238 A1
(43) Pub. Date: May 20, 2010

(54) METHOD AND APPARATUS FOR FORMING SUPERFRAME FOR QoS AND MULTIPLE LINK CONNECTIONS IN LOW-RATE WIRELESS NETWORK

(75) Inventors: Yong Geun HONG, Daejeon-city (KR); Yong Woon Kim, Cheonan-Si (KR); Park Hee-Dong, Cheonan-Si (KR)

Correspondence Address: STAAS & HALSEY LLP, SUITE 700, 1201 NEW YORK AVENUE, N.W., WASHINGTON, DC, 20005, US

(73) Assignees: ELECTRONICS AND TELECOMMUNICATIONS RESEARCH INSTITUTE, Daejeon-city (KR); KOREA NAZARENE UNIVERSITY INDUSTRY-ACADEMIC COOPERATION FOUNDATION, Chungcheongnam-Do (KR)

(21) Appl. No.: 12/565,036

(22) Filed: Sep. 23, 2009

(30) Foreign Application Priority Data
Nov. 18, 2008 (KR) 10-2008-01114753

(51) Int. Cl. H04J 3/24

(52) U.S. Cl. 370/474

(57) ABSTRACT

Provided is a method and apparatus for forming a superframe in a low-rate wireless personal area network. The structure of an IEEE 802.15.4 superframe is extended to support QoS by increasing the number of GTSs and to minimize waste of a bandwidth through the precise resource reservation although the SO value increases. Thus, since more efficient resource reservation is available compared to an existing IEEE 802.15.4 and the number of GTSs to be assigned is increased to a maximum of 127, simultaneous multiple link connections to more number of devices are available.

### CROSS-REFERENCE TO RELATED PATENT APPLICATION

This application claims the benefit of Korean Patent Application No. 10-2008-0114753, filed on Nov. 18, 2008, in the Korean Intellectual Property Office, the disclosure of which is incorporated herein in its entirety by reference.

### BACKGROUND OF THE INVENTION

1. Field of the Invention

The present invention relates to a method and apparatus for forming a superframe in a low-rate wireless personal area network (WPAN), and more particularly, to a method and apparatus for forming an extended superframe by extending the structure of a superframe of IEEE 802.15.4 to minimize waste of a wireless frequency bandwidth, support quality of service (QoS), and simultaneously enable multiple link connections in a low-rate WPAN.

2. Description of the Related Art

A wireless personal area network (WPAN) and a wireless body area network (WBAN) support various applications from a sensor application and general data transmission to medical data transmission, and provides QoS suitable for each application.

IEEE 802.15 WPAN working group works on the standardization of a physical layer and a data link layer to provide wireless connections in a personal operating space (POS) that is the space about a person that typically extends up to 10 meters in all directions and envelops the person whether stationary or in motion. IEEE 802.15.4 studies about medium access control and the physical layer with respect to a lower rate-WPAN (LR-WPAN) and purposes use of a service at a transmission speed of 20-250 kbps, at low cost and power, and within a distance of 30 m.

In the current superframe structure of IEEE 802.15.4, the number of guaranteed time slots (GTS) assigned to guarantee QoS is limited to 7. Also, since the value of a slot duration SlotD exponentially increases as a superframe order (SO) value increases, it is highly likely to reserve wireless resources over a demand by a device, it is a problem that a bandwidth may be wasted.

### SUMMARY OF THE INVENTION

The present invention provides a method and apparatus for extending the structure of a superframe of IEEE 802.15.4 to minimize waste of a wireless frequency bandwidth, support QoS, and simultaneously enable multiple link connections to support services of a plurality of devices in a WPAN and a WBAN, so that the number of GTSs may increases and, although the SO value increases, waste of a bandwidth may be minimized through precise resources reservation.

The other purposes and advantageous may be understood through the following descriptions and will be more clearly understood by the embodiments of the present invention. Also, it may be easily understood that the purposes and advantages of the present invention are realized by the constituent elements defined in the attached clams and a combination thereof.

According to an aspect of the present invention, there is provided a method of forming a superframe by a coordinator in a low-rate wireless network, which includes determining a superframe order value used for determining an active period of the superframe, the superframe including the active period and an inactive period, and determining a maximum number of time slots of a contention free period forming the active period based on the superframe order value.

According to another aspect of the present invention, there is provided an apparatus for forming a superframe by a coordinator in a low-rate wireless network, which includes a superframe structure determination unit determining a superframe order value used for determining an active period of the superframe, the superframe including the active period and an inactive period, and a time slot determination unit determining a maximum number of time slots of a contention free period forming the active period based on the superframe order value.

According to another aspect of the present invention, there is provided a method of generating a beacon frame in a low-rate wireless network, which includes providing a contention free period extended bit in a reserved sub-field of a superframe specification field to indicate a method of determining a maximum number of guaranteed time slots that are time slots of a contention free period forming an active period of a super frame, the superframe including the active period and an inactive period, removing a reserved sub-field of a guaranteed time slot specification field to extend the number of the guaranteed time slots, and adding bits of the removed sub-field to a descriptor count sub-field, extending the number of bits of a direction mask sub-field in a guaranteed time slot direction field to enable bit extension according to a descriptor count value of the guaranteed time slot specification field, and extending the number of bits of a starting slot and a length sub-field in a guaranteed time slot list field.

According to another aspect of the present invention, there is provided a method of forming a guaranteed time slot request command frame that is a time slot of a contention free period forming an active period of a super frame in a low-rate wireless network, the superframe including the active period and an inactive period, which includes extending the number of bits of a guaranteed time slot length sub-field in a guaranteed time slot characteristics field of the guaranteed time slot request command frame, when a maximum number of guaranteed time slots is determined based on a superframe order value used for determining the active period.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates the structure of a superframe defined by IEEE 802.15.4;

FIG. 2 illustrates a change in the slot number and the number of slots in a CFP section when the SO value is 4 in Table 1, according to an embodiment of the present invention;

FIG. 3 illustrates a superframe specification field changed for compatibility with an existing IEEE 802.15.4 standard, according to an embodiment of the present invention;

FIG. 4 illustrates a GTS specification field changed for compatibility with an existing IEEE 802.15.4 standard, according to an embodiment of the present invention;

FIG. 5 illustrates a GTS direction field changed for compatibility with an existing IEEE 802.15.4 standard, according to an embodiment of the present invention;

FIG. 6 illustrates a GTS list field changed for compatibility with an existing IEEE 802.15.4 standard, according to an embodiment of the present invention;

FIG. 7 illustrates a GTS characteristics field of a GTS request command frame changed for compatibility with an existing IEEE 802.15.4 standard, according to an embodiment of the present invention;

FIG. 8 is a flowchart for explaining a method of forming a superframe in a low-rate wireless network, according to an embodiment of the present invention;

FIG. 9 is a block diagram schematically illustrating the interior structure of an apparatus for forming a superframe in a low-rate wireless network, according to an embodiment of the present invention; and

FIG. 10 illustrates that GTS1 and GTS2 are assigned to nodes A and B that periodically transmit data of 2000 bytes and 4000 bytes, respectively, when the SO value is 7 in an OQPSK 250 kbps system of IEEE 802.15.4.

### DETAILED DESCRIPTION OF THE INVENTION

The present invention will now be described more fully with reference to the accompanying drawings, in which exemplary embodiments of the invention are shown. Throughout the drawings, like reference numerals denote like elements. In the following description, when detailed descriptions about related well-known functions or structures are determined to make the gist of the present invention unclear, the detailed descriptions will be omitted herein.

When a part may “include” a certain constituent element, unless specified otherwise, it may not be construed to exclude another constituent element but may be construed to further include other constituent elements. The terms such as “˜portion”, “˜unit”, “˜module”, and “˜block” stated in the specification may signify a unit to process at least one function or operation and one that may be embodied by hardware, software, or a combination of hardware and software. Also, as a computer software command to embody the present invention, hardware, software, or a combination of hardware and software may be used instead of a programmed processor/controller. Accordingly, the present invention is not limited by a specific combination of hardware and software.

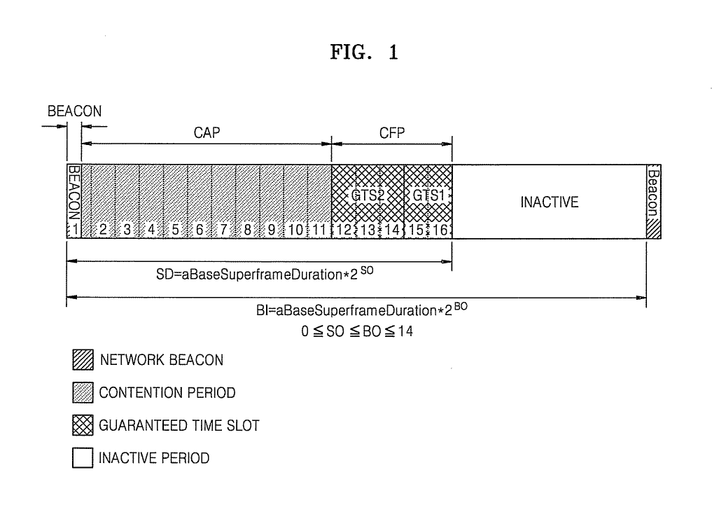

FIG. 1 illustrates the structure of a superframe defined by IEEE 802.15.4. A coordinator of a personal area network (PAN) may selectively restrict a channel time by using a superframe structure of FIG. 1.

Referring to FIG. 1, the range of a superframe is determined by a beacon that the coordinator transmits in a previously set interval. The superframe is divided into 16 slots having the same size. A beacon frame is transmitted in the first slot of the superframe. A beacon interval may be between a minimum of 15 ms and a maximum of 145 seconds. The beacon is used to synchronize connected devices, identify the PAN, and describe the superframe structure. The time between two beacons is divided into 16 identical time slots regardless of the period of the superframe. The devices may transmit data anytime during a time slot, but necessarily completes data transceiving before the next superframe beacon. The beacon includes a superframe specification and notification of a pending node message.

The superframe may be divided into an active period and an inactive period. The inactive period is used as a low power mode. The active period may be divided into a contention access period (CAP; hereinafter, referred to as “contention period”) and a contention free period (CFP; hereinafter, referred to as “non-contention period”). In the CAP, devices desiring communications use a slotted carrier sense multiple access-contention avoidance (CSMA-CA) method. In contrast, the CFP is divided into guaranteed time slots (GTSs) and used for data transmission that is necessarily guaranteed quality of service (QoS). For example, the coordinator may provide GTS for realtime application or an applied service mainly requiring a special bandwidth. A PAN coordinator may assign a maximum of 7 GTSs, and each GTS includes one or more slot. The inactive period may enter the low power mode (sleep) without an interaction between the coordinator and the PAN.

The structure of a superframe may be adjusted using a superframe order (SO) value and a beacon order (BO) value, which are included in the beacon. The two values are in a range of 0≦SO≦BO≦14, where BO and SO values are integers. When the SO and BO have a value of 15, a network operates as a non beacon-enabled PAN so as not to have a superframe structure. Each superframe is divided into a superframe duration (SD) and a beacon interval (BI) by the BO and SO values. The SD period, that is, the active period, is always divided into 16 slots regardless of the BI value. The SD period is further divided into the CAP period and the CFP period as described above. Information about the boundary between the CAP period and the CFP period and the GTS assignment in the CFP are updated and broadcasted for each beacon. A maximum of 7 GTSs may be assigned in the CFP period. Each GTS includes one or more slot.

A low-rate wireless PAN (WPAN) uses one of two channel access mechanisms according to the structure of a network. The slotted CSMA-CA method is used for a PAN using a beacon having a superframe. An unslotted CSMA-CA method is used for a PAN using no beacon.

In a network using no beacon, when a device desires data transmission, whether another device is transmitting data through the same channel is checked. If the channel is in use, the transmission by the device is canceled during a random period. Or after making a few trials, if the transmission fails, a transmission failure is indicated. The transmission check frame does not use a carrier sense multiple access-contention avoidance (CSMA) method because the transmission check frame is transmitted directly after a receiving packet.

In a network using a beacon, when data transmission is desired in a period during which a device makes contention access, the start of a next time slot is waited for and, if another device uses the same slot, the transmission is canceled during a random period. Or after making a few trials, if the transmission fails, a transmission failure is indicated. In the network using a beacon, the transmission check frame does not use the CSMA method.

Traffic of the WPAN and the WBAN may be divided into periodic traffic and non-periodic traffic. The periodic traffic is generated by a sensor that samples data for each period and transmits the sampled data. The non-periodic traffic includes event-driven messages generated when control messages are exchanged or when necessary. In general, the non-periodic traffic does not require a reserved bandwidth because the amount of generation of traffic may not be predicted. The CAP that is a contention based access in the superframe structure of IEEE 802.15.4 may be used for the transmission of the non-periodic control command.

For an application requiring less delay time or a special bandwidth, the QoS may be supported as the coordinator uses the GTS in the active superframe. However, since a maximum of 7 GTSs may be used in a superframe according to the definition of IEEE 802.15.4, scalability may be deteriorated. Thus, the number of GTSs needs to be increased to support a plurality of devices requiring a variety of QoSs in the WPAN and the WBAN.

The superframe structure of IEEE 802.15.4 determines the length of the BI and SD period using the BO and SO values. The SD period is always divided into 16 of the same time slots regardless of the BO and SO values. Thus, as the SO value increases, a bandwidth that may be provided for each slot exponentially increases. In an IEEE 802.15.4 standard superframe structure in which a bandwidth is assigned in units of slots, as the SO value increases, precise assignment of a bandwidth by GTS becomes more difficult. That is, as the SO value increases, a possibility to assign resource over a bandwidth required by a particular device, so that waste of the bandwidth may increase.

The present invention suggests a new superframe structure which increases the number of GTSs to support QoS and minimizes waste of a bandwidth through precise resource reservation, even if the SO value increases, in the WPAN and the WBAN. According to the suggested method, a bandwidth may be adaptively assigned by reducing the length of a slot in the CFP period according to the SO value.

Table 1 shows a slot length value SlotD in the CFP that changes according to an SO value range according to an embodiment of the present invention. According to Table 1, as an example, the SO value is divided into 5 ranges and the slot length value SlotD in the CFP is changed according to a corresponding range. When the SO value is between 0-2, a network operates the same as the existing IEEE 802.15.4. However, when the SO value is 3 or higher, as the SO value increases, the slot length value SlotD in the CFP is reduced so that the number of slots in the CFP and the number of GTSs may be increased and more precise bandwidth assignment may be possible. In Table 1, “FinalCAPSlot” denotes the number of the final slot in the CAP period.

For example, when the SO value is 6, the SO value belongs to range 3 so that the ratio between the time slot length of the CFP (SlotD_CFP) and the time slot length of the CAP (SIotD_CAP) may be reduced to ¼. Thus, as the slot length value in the CFP decreases and the maximum number of slots in the CFP is increased to 20[4×(15−FinalCAPSlot)], where the final slot number of the CAP is 10, so that the number of GTSs may be increased.

TABLE 1

| | | SlotD_CFP/ | Maximum Available Slot |
|---|---|---|---|
| Classification | SO Value | SlotD_CAP | Number in CFP |
| Range 1 | 0~2 | 1 | 15-FinalCAPSIot |
| Range 2 | 3~5 | ½ | 2 × (15-FinalCAPSlot) |
| Range 3 | 6~8 | ¼ | 4 × (15-FinalCAPSlot) |
| Range 4 | 9~11 | ⅛ | 6 × (15-FinalCAPSlot) |
| Range 5 | 12~14 | 1/16 | 8 × (15-FinalCAPSlot) |

In the present embodiment, the increase in the slot number according to the decrease in the SlotD value is limited to the CFP and the SlotD of the CAP is not changed. The SlotD value of the CAP may be increased in the same method as necessary. The starting slot number of the CFP restarts from 0.

In the present embodiment, the SO value is divided into 5 ranges to change the maximum available slot number in the CFP. The range of the SO value may be differently set according to a network environment or a decision by a system operator.

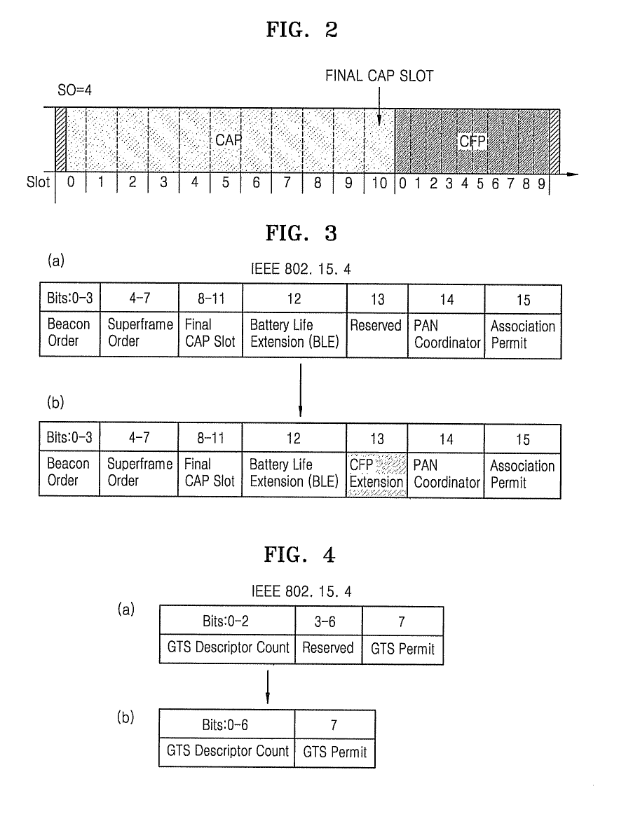

FIG. 2 illustrates a change in the slot number and the number of slots in a CFP section when the SO value is 4 in Table 1, according to an embodiment of the present invention. Referring to FIG. 2, the CFP corresponding to 5 slots from number 11 to number 15 according to the IEEE 802.15.4 standard technology may be divided into a total of 10 slots from number 0 to number 9 by reducing the SlotD by ½ because the SO value is 4 in the present embodiment. Even when the starting slot number of the CFP starts from 0, the PAN coordinator and device may identify the position of each slot in the CFP using the final CAP slot field information of a beacon frame.

As the slot number of the CFP increases, more number of GTSs may be assigned and simultaneously the SlotD value is decreased by ½ so that waste of a bandwidth in a slot may be reduced by ½ on the average.

To embody the above method of the present invention, some fields of a beacon frame and a GTS request command frame of a MAC command frame of the existing IEEE 802.15.4 are changed. First, of the beacon frame, the fields needing change are a superframe specification field, a GTS specification field, a GTS direction field, and a GTS list field. In FIGS. 3-7, a detailed description about an existing IEEE 802.15.4 standard field will be omitted herein.

FIG. 3 illustrates a superframe specification field changed for compatibility with an existing IEEE 802.15.4 standard, according to an embodiment of the present invention. Referring to FIG. 3, in Table (a), the 13^{th} sub-field of the superframe specification field of the IEEE 802.15.4 standard is a reserved sub-field. In Table (b) of FIG. 3, to which the present invention is applied, a changed superframe specification field changes the reserved 13^{th} sub-field to a CFP extension sub-field. When a CFP extended bit is “1”, the number of slots in the CFP is changed according to the range of the SO value according to the present invention. When the CFP extended bit is “0”, a network operates according to an existing technology by assigning the maximum of 7 GTSs.

FIG. 4 illustrates a GTS specification field changed for compatibility with an existing IEEE 802.15.4 standard, according to an embodiment of the present invention. Referring to FIG. 4, in the GTS specification field that is changed by applying the present invention as shown in Table (b), a maximum of 127 GTSs may be assigned by removing a reserved sub-field of the GTS specification field of the IEEE 802.15.4 standard and extending the length of a GTS descriptor count sub-field length as long as the length of the removed reserved sub-field.

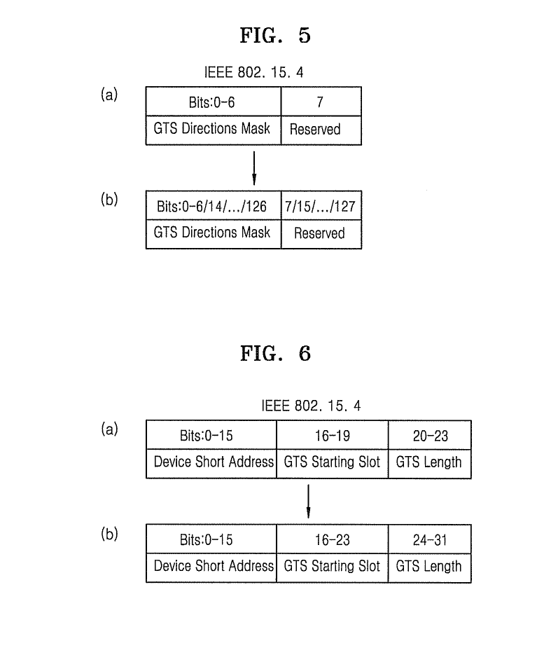

FIG. 5 illustrates a GTS direction field changed for compatibility with an existing IEEE 802.15.4 standard, according to an embodiment of the present invention. Since a maximum of 127 GTSs are available, a GTS direction mask bit sub-field of the GTS direction field needs to be extended to a maximum of 127 bits. Referring to FIG. 5, in the GTS direction field changed by applying the present invention as shown in Table (b), the GTS direction field of basic 1 byte (8 bits) is changed to be extended in units of bytes to a maximum of 16 bytes (128 bits) according to GTS descriptor count information of the GTS specification field. Thus, the changed GTS direction field has extended bits greater than the GTS direction field of the IEEE 802.15.4 standard of Table (a).

FIG. 6 illustrates a GTS list field changed for compatibility with an existing IEEE 802.15.4 standard, according to an embodiment of the present invention. Referring to FIG. 6, in the GTS list field of the IEEE 802.15.4 standard of Table (a), each of the GTS starting slot and the GTS length is 4 bits. In the GTS list field changed by applying the present invention in Table (b), since the number of slots in the CFP may be extended to a maximum of 256, the GTS starting slot and the GTS length are extended to 8 bits to represent a maximum of 256.

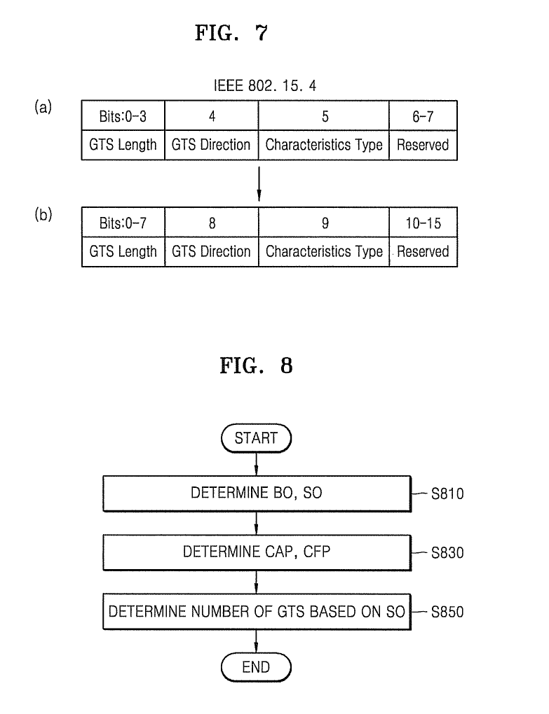

FIG. 7 illustrates a GTS characteristics field of a GTS request command frame changed for compatibility with an existing IEEE 802.15.4 standard, according to an embodiment of the present invention. With the change of a beacon frame, some fields of the GTS request command frame of the MAC command frame needs to be changed. Referring to FIG. 7, the GTS length sub-field of a GTS characteristics field of the IEEE 802.15.4 standard in Table (a) is 4 bits. In the GTS characteristics field changed by applying the present invention in Table (b), the GTS length sub-field is extended to 8 bits to represent a maximum of 256.

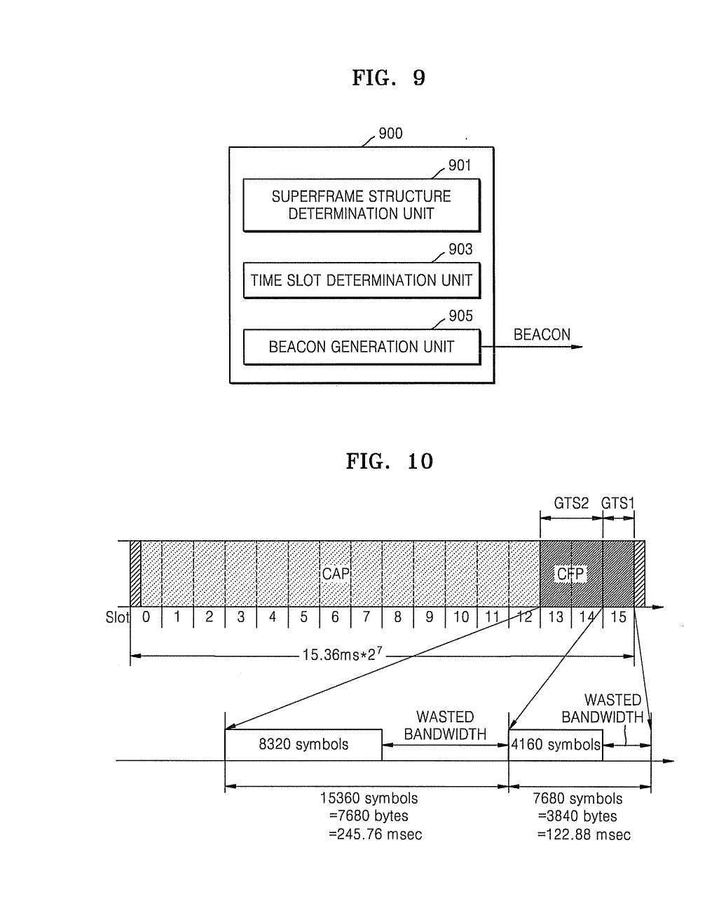

FIG. 8 is a flowchart for explaining a method of forming a superframe in a low-rate wireless network, according to an embodiment of the present invention. FIG. 9 is a block diagram schematically illustrating the interior structure of a superframe forming apparatus 900 in a low-rate wireless network, according to an embodiment of the present invention. The method of forming a superframe is described below referring to the structure of a superframe forming apparatus.

Referring to FIGS. 8 and 9, the superframe forming apparatus 900 includes a superframe structure determination unit 901, a time slot determination unit 903, and a beacon generation unit 905. The superframe structure determination unit 901 determines a superframe order (SO) value used for the determination of an active period of a superframe and a beacon order (BO) value used for the determination of a beacon interval (BI) (S810). The superframe includes the active period and an inactive period.

The time slot determination unit 903 determines the CAP and the CFP in the active period and assigns a time slot and a time slot number to the CAP (S830). The time slot determination unit 903 determines the maximum number of time slots in the CFP based on the SO value (S850). The time slot determination unit 903 determines whether to follow an existing standard method or a method of determining the number of time slots based on the superframe order value, in the determination of the number of GTSs that are time slots in the CFP. The time slot determination unit 903 checks a range, to which the SO value belongs, and decreases the length of the GTS when the SO value increases, so that the ratio in the length of the time slots in the CAP and the CFP. Thus, the maximum number of time slots in the CFP is increased.

The beacon generation unit 905 generates and transmits a beacon frame by indicating information about the determined superframe structure and time slot in a frame field. The beacon generation unit 905 provides an extended bit in the CFP to a reserved sub-field in the superframe specification field to indicate the method of determining the maximum number of GTSs. The extended bit in the CFP may be set to “1” so as to determine the maximum number of GTSs based on the SO value used for the determination of an active period. The beacon generation unit 905 removes the reserved sub-field of the GTS specification field to extend the number of GTSs and adds the bits of the removed sub-field to a descriptor count sub-field. The beacon generation unit 905 extends the number of bits of a direction mask sub-field in the GTS direction field to enable the extension of bits according to the descriptor count value of the GTS specification field. The beacon generation unit 905 extends the number of bits of the GTS starting slot and the GTS length sub-field in the GTS list field.

During the generation of a GTS request command frame, when the maximum number of GTSs is determined based on the SO value used for the determination of an active period, the number of bits of the GTS length sub-field in the GTS characteristics field of the GTS request command frame is extended.

The comparison in the data transmission between a conventional technology and the present invention will be described below.

FIG. 10 illustrates that GTS1 and GTS2 are assigned to nodes A and B that periodically transmit data of 2000 bytes (4000 symbols) and 4000 bytes (8000 symbols), respectively, when the SO value is 7 in an OQPSK 250 kbps system of IEEE 802.15.4.

In the IEEE 802.15.4 superframe structure, the SD denotes the number of symbols in the active period and the BI denotes the total number of symbols of the active and inactive periods. The SlotD (slot duration) that is the length of a slot may be expressed by Equation 1.

SlotD=aBaseSlotDuration×2^{SO} [Equation 1]

In Equation 1, the term “aBaseSlotDuration” denotes the number of symbols forming a slot when the SO value is 0. In the IEEE 802.15.4 standard, the SO value is fixed to 60. The term “aBaseSuperframeDuration” denotes the number of symbols forming a superframe when the SO value is 0, which may be expressed by Equation 2. In the IEEE 802.15.4 standard, the SO value is fixed to 16.

aBaseSuperframeDuration=aBaseSlotDuration×aNumSuperframeSlots×2^{SO} [Equation 2]

Since the maximum number of symbols phyMaxFrameDuration that may be transmitted in a physical layer is 1064, data of the node A is divided into 4 frames by 4 long interframe spacing (LIES). Considering the minimum number of symbols macMinLIFSPeriod in the LIES is 40, the total number of symbols occupied by the node A is 4160. However, it is assumed that acknowledgement is not used. Likewise, since the node B needs 8 LIFSs, a total 8320 symbols are occupied.

7680 symbols may be transmitted during one superframe slot according to Equation 1, which means data of 3840 bytes for 122.88 msec in the OQPSK 250 kbps. Thus, the PAN coordinator receiving a request for GTS assignment from a node assigns a slot to GTS1 and two slots to GTS2. However, it can be seen that a bandwidth loss is generated corresponding to 3520 symbols for GTS1 and 7040 symbols for GTS2. The bandwidth loss further increases as the SO value increases. Theoretically, resource that may be wasted in one GTS slot may be as many as the number of symbols between 0 to (slotD-1). Thus, as the SlotD value of a symbol forming the GTS increases, waste of a bandwidth may increase.

When the method according to the present invention is applied to the above-described example, it can be seen that much more efficient assignment of resource may be possible compared to the existing IEEE 802.15.4.

In Table 2, resources assigned to the two GTSs according to the IEEE 802.15.4 and the method of the present invention are compared with each other.

TABLE 2

| | GTS1 | | | GTS2 | | |
|---|---|---|---|---|---|---|
| | Requested | Assigned | Wasted | Requested | Assigned | Wasted |
| | Resource | Resource | Resource | Resource | Resource | Resource |
| Classification | (Symbol) | (Symbol) | (Symbol) | (Symbol) | (Symbol) | (Symbol) |
| IEEE | 4,160 | 7,680 | 3,520 | 8,320 | 15,360 | 7,040 |
| 802.15.4 | | | | | | |
| Present | 4,160 | 5,760 | 1,600 | 8,320 | 9,600 | 1,280 |
| Invention | | | | | | |

As described above, the method according to the present invention can much more efficiently reserve resource compared to the existing IEEE 802.15.4. Also, since the number of GTSs that may be assigned is 127 at its maximum, multilink connections to a large number of devices at the same time are possible so that the extensibility of the IEEE 802.15.4 may be solved.

Also, according to the present invention, the structure of an IEEE 802.15.4 superframe is extended to support QoS by increasing the number of GTSs and to minimize waste of a bandwidth through the precise resource reservation although the SO value increases. Thus, since more efficient resource reservation is available compared to the existing IEEE 802.15.4 and the number of GTSs to be assigned is increased to a maximum of 127, simultaneous multiple link connections to more number of devices are available.

In another embodiment, as a computer software command to embody the present invention, hardware, software, or a combination of hardware and software may be used instead of a programmed processor/controller. Accordingly, the present invention is not limited by a specific combination of hardware and software.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, etc. The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

While the present invention has been particularly shown and described with reference to preferred embodiments using specific terminologies, the embodiments and terminologies should be considered in descriptive sense only and not for purposes of limitation. Therefore, it will be understood by those of ordinary skill in the art that various changes in form and details may be made therein without departing from the spirit and scope of the present invention as defined by the following claims.

Therefore, it will be understood by those skilled in the art that various changes in form and details may be made therein without departing from the spirit and scope of the invention as defined by the appended claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of forming a superframe by a coordinator in a low-rate wireless network, the method comprising:
determining a superframe order value used for determining an active period of the superframe, the superframe including the active period and an inactive period; and
determining a maximum number of time slots of a contention free period forming the active period based on the superframe order value.

2. The method of claim 1, wherein the determining of a maximum number of time slots of a contention free period comprises changing the maximum number of time slots by changing a time slot length value of the contention free period according to the superframe order value.

3. The method of claim 1, wherein the position of a time slot of the contention free period is identified from final time slot field information of a contention period forming the active period with the contention free period.

4. The method of claim 2, wherein the changing of the maximum number of time slots comprises changing the maximum number of time slots by decreasing the time slot length value of the contention free period and increasing a maximum time slot number when the superframe order value increases.

5. An apparatus for forming a superframe by a coordinator in a low-rate wireless network, the apparatus comprising:
a superframe structure determination unit determining a superframe order value used for determining an active period of the superframe, the superframe including the active period and an inactive period; and
a time slot determination unit determining a maximum number of time slots of a contention free period forming the active period based on the superframe order value.

6. The apparatus of claim 5, wherein the time slot determination unit changes the maximum number of time slots by changing a time slot length value of the contention free period according to the superframe order value.

7. The apparatus of claim 5, wherein the position of a time slot of the contention free period is identified from final time slot field information of a contention period forming the active period with the contention free period.

8. A method of generating a beacon frame in a low-rate wireless network, the method comprising:
providing a contention free period extended bit in a reserved sub-field of a superframe specification field to indicate a method of determining a maximum number of guaranteed time slots that are time slots of a contention free period forming an active period of a super frame, the superframe including the active period and an inactive period;
removing a reserved sub-field of a guaranteed time slot specification field to extend the number of the guaranteed time slots, and adding bits of the removed sub-field to a descriptor count sub-field;
extending the number of bits of a direction mask sub-field in a guaranteed time slot direction field to enable bit extension according to a descriptor count value of the guaranteed time slot specification field; and
extending the number of bits of a starting slot and a length sub-field in a guaranteed time slot list field.

9. The apparatus of claim 8, wherein the providing of a contention free period extended bit comprises setting the contention free period extended bit to 1 to determine the maximum number of the guaranteed time slots based on a superframe order value used for determining the active period.

10. A method of forming a guaranteed time slot request command frame that is a time slot of a contention free period forming an active period of a super frame in a low-rate wireless network, the superframe including the active period and an inactive period, the method comprising:
extending the number of bits of a guaranteed time slot length sub-field in a guaranteed time slot characteristics field of the guaranteed time slot request command frame, when a maximum number of guaranteed time slots is determined based on a superframe order value used for determining the active period.
